(19) United States
(12) Patent Application Publication
(10) Pub. No.: US 2020/0159346 A1
(43) Pub. Date: May 21, 2020

(54) TOUCHPAD MODULE AND COMPUTING DEVICE USING SAME

(71) Applicant: PRIMAX ELECTRONICS LTD., Taipei City (TW)

(72) Inventor: TAI-SOU HUANG, Taipei City (TW)

(21) Appl. No.: 16/254,690

(22) Filed: Jan. 23, 2019

(30) Foreign Application Priority Data
Nov. 16, 2018 (TW) 107140876

(51) Int. Cl. G06F 3/0354; G06F 1/16; H01H 13/50

(52) U.S. Cl. CPC G06F 3/03547; G06F 1/169; H01H 13/50; H01H 2215/004; H01H 2231/002; H01H 2207/032; G06F 1/1616

(57) ABSTRACT

A touchpad module for a computing device is provided. The computing device includes a fixing frame. The touchpad module includes a touch member, a switch, a base plate and a triggering film layer. The touch member is disposed within the fixing framer. The switch is disposed on the touch member. The base plate is disposed within the fixing frame and opposed to the touch member. The base plate includes a perforation. The switch is aligned with the perforation. The triggering film layer is arranged between the base plate and the switch. The perforation of the base plate is covered by the triggering film layer. The present invention also provides a computing device with the touchpad module.

### FIELD OF THE INVENTION

The present invention relates to an input device, and more particularly to an input device with a touch control function.

### BACKGROUND OF THE INVENTION

With increasing development of science and technology, a variety of electronic devices are designed in views of convenience and user-friendliness. For helping the user well operate the electronic devices, the electronic devices are gradually developed in views of humanization. The common electronic devices include for example notebook computers, mobile phones, satellite navigation devices, or the like. Recently, the storage capacity and the processor's computing performance for these electronic devices are largely enhanced, and thus their functions become more powerful and complicated. For efficiently operating an electronic device, a touchpad is used as an input device of the electronic device for controlling the operations of the electronic device.

FIG. 1 schematically illustrates a conventional notebook computer with a touchpad module. As shown in FIG. 1, the touchpad module 1 is installed on a casing 21 of the notebook computer 2. Moreover, at least a portion of the touchpad module 1 is exposed outside so as to be touched by the user's finger. Consequently, the user may operate the touchpad module 1 to control the notebook computer 2. For example, in case that the user's finger is placed on the touchpad module 1 and slid on the touchpad module 1, a cursor 23 shown on a display screen 22 of the notebook computer 2 is correspondingly moved. Moreover, in case that the touchpad module 1 is pressed down by the user's finger, the notebook computer 2 executes a specified function. The use of the touchpad module 1 can implement some functions of the conventional mouse. In other words, the user may operate the notebook computer 2 through the touchpad module 1 without the need of additionally carrying or installing the mouse.

FIG. 2 is a schematic cross-sectional view illustrating the touchpad module as shown in FIG. 1, in which the touchpad module is not pressed down. FIG. 3 is a schematic cross-sectional view illustrating the touchpad module as shown in FIG. 2, in which the touchpad module is pressed down. FIG. 4 is a schematic cross-sectional view illustrating portions of a circuit board and a switch of the touchpad module as shown in FIG. 2, in which the touchpad module is not pressed down. FIG. 5 is a schematic cross-sectional view illustrating portions of the circuit board and the switch of the touchpad module as shown in FIG. 3, in which the touchpad module is pressed down. As shown in FIGS. 2, 3, 4 and 5, a fixing frame 24 is concavely formed in the casing 21 of the notebook computer 2. A supporting structure 241 and a triggering part 242 are respectively protruded from two opposite sides of an inner wall of the fixing frame 24. A first end 11 of the touchpad module 1 is connected with the supporting structure 241. Consequently, a second end 12 of the touchpad module 1 may be swung relative to the triggering part 242 by using the supporting structure 241 as a fulcrum.

The touchpad module 1 further comprises a switch 13 and a circuit board 14. The switch 13 is located under the second end 12 of the touchpad module 1 and aligned with the triggering part 242. The switch 13 comprises a metal dome 131. A first conducting part 141 and a second conducting part 142 corresponding to the metal dome 131 are disposed on the circuit board 14. The first conducting part 141 and the second conducting part 142 are separated from each other by a spacing distance. When the touchpad module 1 is not pressed down, the metal dome 131 is not subjected to deformation. Meanwhile, as shown in FIG. 4, the metal dome 131 is contacted with the second conducting part 142 but not contacted with the first conducting part 141.

While the touchpad module 1 is pressed down by the user, the second end 12 of the touchpad module 1 is swung downwardly relative to the triggering part 242 by using the supporting structure 241 as a fulcrum. When the switch 13 of the touchpad module 1 is pushed by the triggering part 242 of the fixing frame 24, the metal dome 131 is subjected to deformation. At the same time, the metal dome 131 is contacted with both of the first conducting part 141 and the second conducting part 142 (see FIG. 5), and the electric connection between the first conducting part 141 and the second conducting part 142 is established. Under this circumstance, the switch 13 is triggered to generate a switch signal to the notebook computer 2. According to the switch signal, the notebook computer 2 executes a corresponding function. When the touchpad module 1 is no longer pressed by the user, the second end 12 of the touchpad module 1 is swung upwardly relative to the triggering part 242 in response to the elastic force of the metal dome 131 and/or the elastic force of the supporting structure 241. Consequently, the metal dome 131 is restored to its original shape (see FIG. 4) and the touchpad module 1 is returned to its original position.

However, the conventional touchpad module 1 still has some drawbacks. For example, while the touchpad module 1 is pressed down by the user, the deformed metal dome 131 is contacted with the first conducting part 141 and also contacted with the circuit board 14. Due to the click collision between the deformed metal dome 131 and the large-area circuit board 14, unpleasant noise is generated.

Therefore, there is a need of providing an improved touchpad module in order to overcome the above drawbacks.

### SUMMARY OF THE INVENTION

An object of the present invention provides a touchpad module with a triggering film layer and a base plate. Due to the triggering film layer, the sound generated by the touchpad module is effectively reduced. Moreover, the cooperation of the triggering film layer and a perforation of the base plate can adjust the tactile feel of operating the touchpad module.

Another object of the present invention provides a computing device with a touchpad module. The touchpad module includes a triggering film layer and a base plate. Due to the triggering film layer, the sound generated by the touchpad module is effectively reduced. Moreover, the cooperation of the triggering film layer and a perforation of the base plate can adjust the tactile feel of operating the touchpad module.

The other objects and advantages of the present invention will be understood from the disclosed technical features.

In accordance with an aspect of the present invention, there is provided a touchpad module for a computing device. The computing device includes a fixing frame. The touchpad module includes a touch member, a switch, a base plate and a triggering film layer. The touch member is disposed within the fixing framer. The switch is disposed on the touch member. The base plate is disposed within the fixing frame and opposed to the touch member. The base plate includes a perforation. The switch is aligned with the perforation. The diameter of the perforation is in the range between 3 mm and 6 mm. The triggering film layer is arranged between the base plate and the switch. The perforation of the base plate is covered by the triggering film layer.

In accordance with another aspect of the present invention, there is provided a computing device. The computing device includes a casing, a processor and a touchpad module. A fixing frame is concavely formed in the casing. The processor is disposed within the casing. The touchpad module is disposed within the fixing frame of the casing and electrically connected with the processor. The touchpad module includes a touch member, a switch, a base plate and a triggering film layer. The touch member is disposed within the fixing framer. The switch is disposed on the touch member. The base plate is disposed within the fixing frame and opposed to the touch member. The base plate includes a perforation. The switch is aligned with the perforation. The diameter of the perforation is in the range between 3 mm and 6 mm. The triggering film layer is arranged between the base plate and the switch. The perforation of the base plate is covered by the triggering film layer.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a conventional notebook computer with a touchpad module;

FIG. 2 is a schematic cross-sectional view illustrating the touchpad module as shown in FIG. 1, in which the touchpad module is not pressed down;

FIG. 3 is a schematic cross-sectional view illustrating the touchpad module as shown in FIG. 2, in which the touchpad module is pressed down;

FIG. 4 is a schematic cross-sectional view illustrating portions of a circuit board and a switch of the touchpad module as shown in FIG. 2, in which the touchpad module is not pressed down;

FIG. 5 is a schematic cross-sectional view illustrating portions of the circuit board and the switch of the touchpad module as shown in FIG. 3, in which the touchpad module is pressed down;

FIG. 6 is a schematic perspective view illustrating the outer appearance of a computing device with a touchpad module according to an embodiment of the present invention;

FIG. 7 is a schematic cross-sectional view illustrating portions of a fixing frame and a touchpad module of the computing device as shown in FIG. 6;

FIG. 8 is a schematic bottom and cutaway view illustrating portions of the fixing frame and the touchpad module as shown in FIG. 7; and

FIG. 9 is a schematic cutaway view illustrating a portion of the touchpad module as shown in FIG. 7.

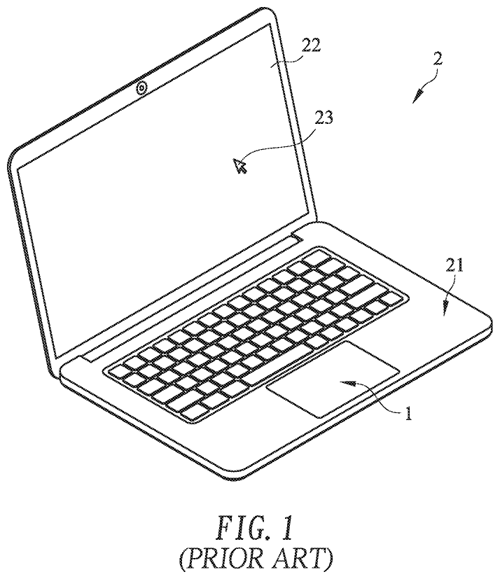

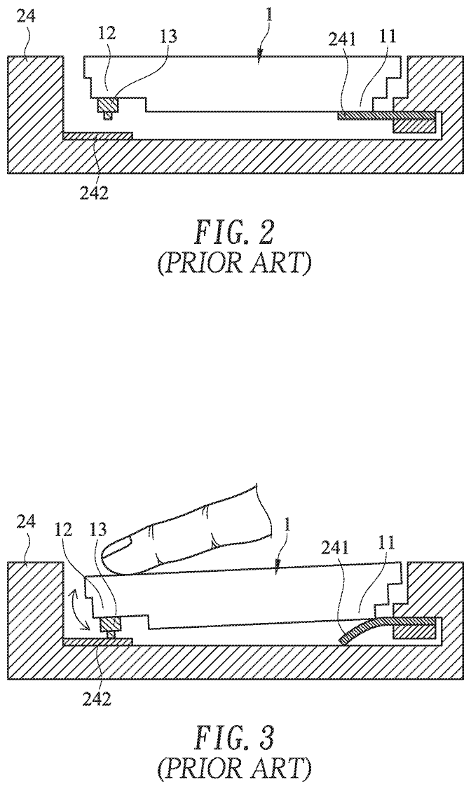

### DETAILED DESCRIPTION OF THE PREFERRED EMBODIMENT

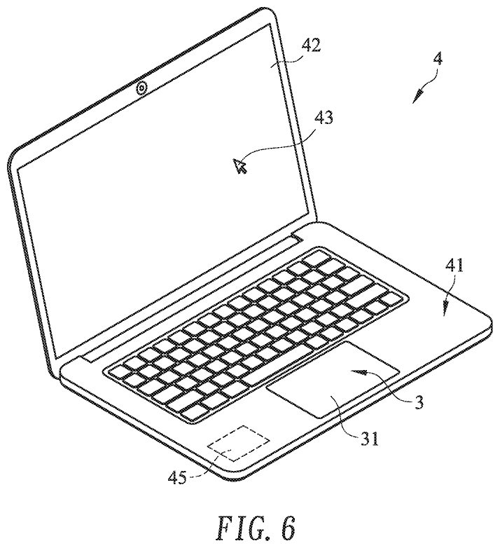

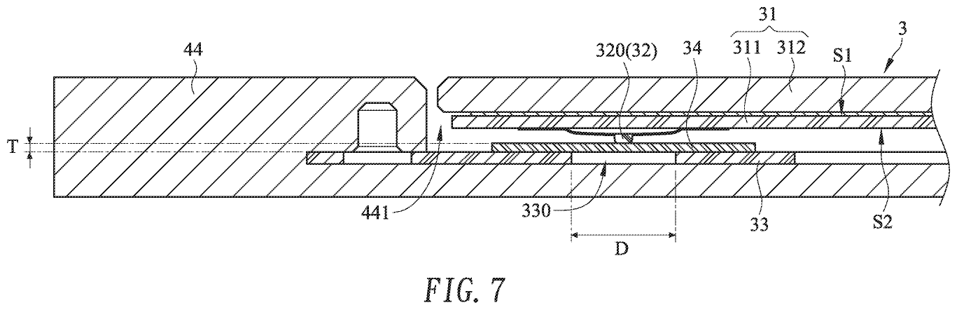

FIG. 6 is a schematic perspective view illustrating the outer appearance of a computing device with a touchpad module according to an embodiment of the present invention. An example of the computing device 4 includes but is not limited to a notebook computer. In an embodiment, the computing device 4 comprises a casing 41, a display screen 42, a processor 45 and a touchpad module 3. The processor 45 is disposed within the casing 41. Moreover, the processor 41 is used for processing electronic signals of the computing device 4. Moreover, a fixing frame 44 is concavely formed in the casing 41 (see FIG. 7). The touchpad module 3 is disposed within the fixing frame 44 and electrically connected with the processor 45. In addition, at least a portion of the touchpad module 3 is exposed outside so as to be touched by the user's finger. Consequently, the user may operate the touchpad module 3 to control the computing device 4. For example, in case that the user's finger is placed on the touchpad module 3 and slid on the touchpad module 3, a cursor 43 shown on the display screen 42 is correspondingly moved. Moreover, in case that the touchpad module 3 is pressed by the user's finger, the computing device 4 executes a specified function.

The other structure of the touchpad module 3 will be described in more details as follows.

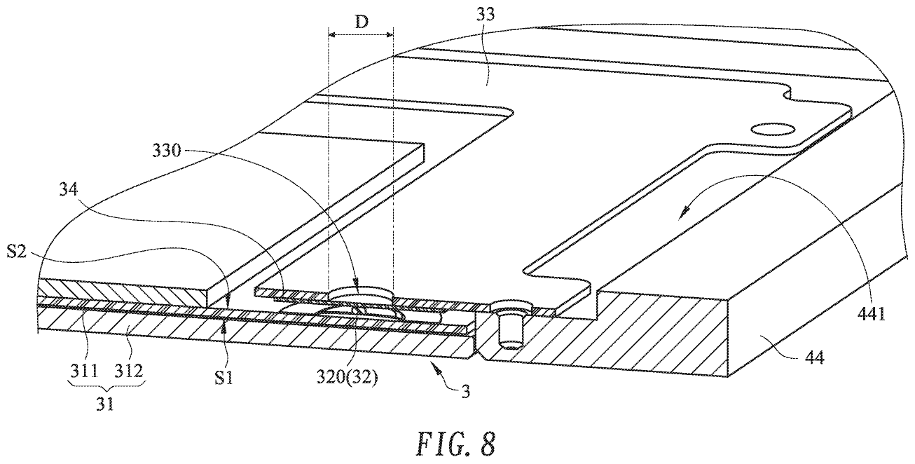

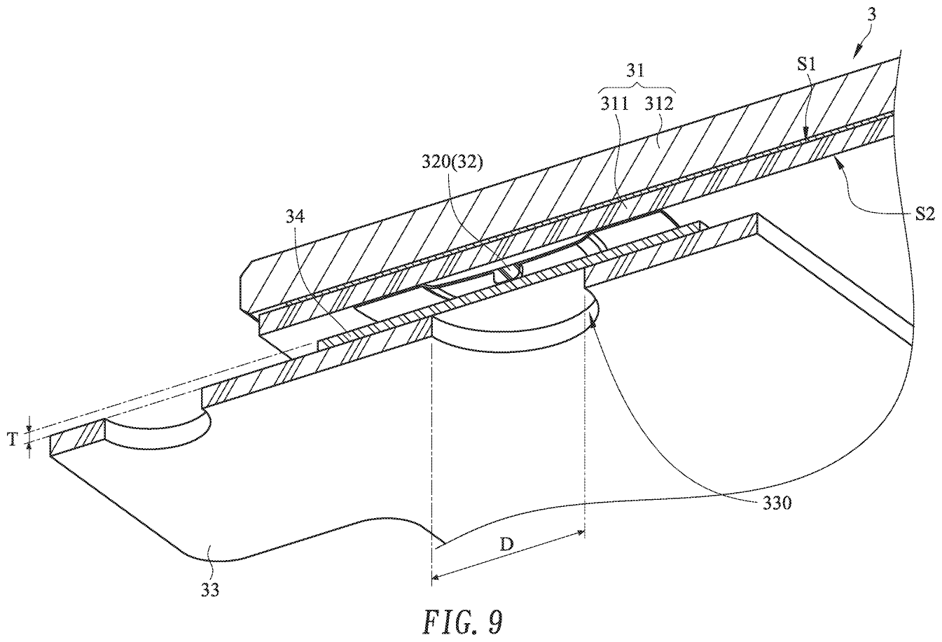

Please refer to FIGS. 7, 8 and 9. FIG. 7 is a schematic cross-sectional view illustrating portions of a fixing frame and a touchpad module of the computing device as shown in FIG. 6. FIG. 8 is a schematic bottom and cutaway view illustrating portions of the fixing frame and the touchpad module as shown in FIG. 7. FIG. 9 is a schematic cutaway view illustrating a portion of the touchpad module as shown in FIG. 7. For succinctness, the bottom wall of the fixing frame is not shown in FIG. 8, and the fixing frame of FIG. 7 is not shown in FIG. 9. As shown in FIGS. 7, 8 and 9, the fixing frame 44 of the computing device 4 comprises an accommodation space 441. The touchpad module 3 is accommodated within the accommodation space 441. In an embodiment, the touchpad module 3 comprises a touch member 31, a switch 32, a base plate 33 and a triggering film layer 34. The touch member 31 is disposed within the fixing frame 44. The switch 32 is disposed on the touch member 31. The base plate 30 is disposed within the fixing frame 44. Moreover, the touch member 31 and the base plate 30 are opposed to each other. The base plate 30 comprises a perforation 330. The switch 32 on the touch member 31 is aligned with the perforation 330 of the base plate 30. The triggering film layer 34 is arranged between the base plate 33 and the switch 32. The perforation 330 of the base plate 30 is covered by the triggering film layer 34.

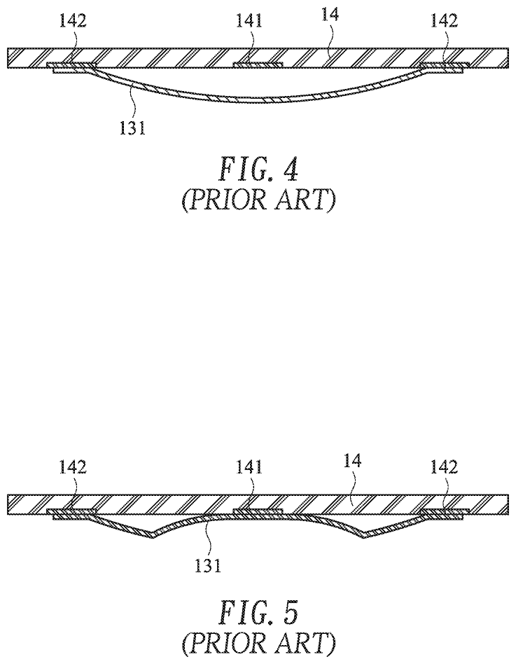

Please refer to FIGS. 7, 8 and 9 again. In this embodiment, the touch member 31 comprises a circuit board 311 and a covering plate 312. The covering plate 312 is located over the circuit board 311. The switch 32 is disposed on the circuit board 311. In this embodiment, the circuit board 311 has a first surface S1 and a second surface S2, which are opposed to each other. The first surface S1 of the circuit board 311 faces the covering plate 312. The second surface S2 of the circuit board 311 faces the base plate 33. The switch 32 is disposed on the second surface S2 of the circuit board 311. The switch 32 comprises a metal dome 320. When an external force is exerted on the touch member 31, the touch member 31 is swung toward the base plate 33. When the switch 32 is pushed by the triggering film layer 34, the metal dome 320 of the switch 32 is subjected to deformation. Consequently, the metal dome 320 is contacted with the circuit board 311. The associated actions will be described in FIGS. 4 and 5 as follows.

In this embodiment, the triggering film layer 34 is arranged between the base plate 33 and the switch 32. When the metal dome 320 of the switch 32 is subjected to deformation and contacted with the circuit board 311, a sound is generated. Moreover, the sound reflected from the circuit board 311 to the base plate 33 is alleviated by the triggering film layer 34. Since the triggering film layer 34 has the function of blocking the sound from being transferred to the base plate 33, the sound generated by the touchpad module 3 is effectively reduced.

In this embodiment, the thickness T of the triggering film layer 34 is in the range between 0.3 mm and 0.8 mm. It is noted that the thickness T of the triggering film layer 34 is not restricted. As long as the sound to be transferred to the base plate 33 is effectively blocked by the triggering film layer 34, the thickness T of the triggering film layer 34 may be varied according to the practical requirements. Preferably but not exclusively, the triggering film layer 34 is made of polyester such as mylar. In another embodiment, the triggering film layer 34 is made of rubber or any other appropriate material that is able to create deformation of the metal dome 320 and block the sound.

As mentioned above, the perforation 330 of the base plate 30 is covered by the triggering film layer 34. Consequently, when the switch 32 is pushed by the triggering film layer 34, the structural strength of the triggering film layer 34 allows the metal dome 320 of the switch 32 to undergo the deformation. Moreover, since a downward force from the switch 32 is applied to the triggering film layer 34, the triggering film layer 34 is pressed and subjected to tiny deformation. Consequently, a portion of the triggering film layer 34 is sunken into the perforation 330 of the base plate 30. As the diameter of the perforation 330 is changed, the cooperation of the triggering film layer 34 and the perforation 330 can adjust the tactile feel of operating the touchpad module 3.

For example, as the diameter D of the perforation 330 of the base plate 30 is increased, the triggering film layer 34 is sunken into the perforation 330 of the base plate 30 more deeply. Under this circumstance, the tactile feel of operating the touchpad module 3 is softer. As the diameter D of the perforation 330 of the base plate 30 is decreased, the triggering film layer 34 is sunken into the perforation 330 of the base plate 30 more shallowly. Under this circumstance, the tactile feel of operating the touchpad module 3 is harder. In this embodiment, the perforation 330 of the base plate 30 is a circular opening. It is noted that the shape of the perforation 330 is not restricted. Preferably but not exclusively, the diameter D of the perforation 330 is in the range between 3 mm and 6 mm. The base plate 33 is made of metallic material. It is noted that the material of the base plate 33 is not restricted.

In an embodiment, the diameter D of the perforation 330 of the base plate 30 is 5 mm, and the thickness T of the triggering film layer 34 is 0.3 mm Due to this structural design, the tactile feel of operating the touchpad module 3 is enhanced. It is noted that the combination of the diameter D of the perforation 330 and the thickness T of the triggering film layer 34 is not restricted. That is, the diameter D of the perforation 330 and the thickness T of the triggering film layer 34 may be varied according to the practical requirements. Due to the design of the present invention, the touchpad module 3 has the functions of blocking the sound and adjusting the tactile feel.

From the above descriptions, the present invention provides the touchpad module and the computing device with the touchpad module. The touchpad module is equipped with the triggering film layer between the base plate and the switch. When the metal dome of the switch is subjected to deformation and contacted with the circuit board, a sound is generated. Moreover, the sound reflected from the circuit board to the base plate is alleviated by the triggering film layer. Consequently, the sound generated by the touchpad module is effectively reduced. As the diameter of the perforation is changed, the cooperation of the triggering film layer and the perforation can adjust the tactile feel of operating the touchpad module. Moreover, since the touchpad module is equipped with the triggering film layer between the base plate and the switch and the perforation in the base plate, the fabricating cost is effectively reduced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touchpad module for a computing device, the computing device comprising a fixing frame, the touchpad module comprising:
a touch member disposed within the fixing frame, wherein the touch member comprises a circuit board and a covering plate, and the covering plate is located over the circuit board;
a switch disposed on the circuit board;
a base plate disposed within the fixing frame and opposed to the circuit board, wherein the base plate comprises a perforation, and the switch is aligned with the perforation; and
a triggering film layer arranged between the base plate and the switch, wherein the perforation of the base plate is covered by the triggering film layer.

2. The touchpad module according to claim 1, wherein when an external force is exerted on the touch member, the touch member is swung toward the base plate and the switch is pushed by the triggering film layer, so that a portion of the triggering film layer is sunken into the perforation.

3. The touchpad module according to claim 1, wherein a diameter of the perforation is in a range between 3 mm and 6 mm.

4. The touchpad module according to claim 1, wherein a thickness of the triggering film layer is in a range between 0.3 mm and 0.8 mm.

5. The touchpad module according to claim 1, wherein a diameter of the perforation is 5 mm, and a thickness of the triggering film layer is 0.3 mm.

6. The touchpad module according to claim 1, wherein the triggering film layer is made of mylar or rubber.

7. (canceled)

8. The touchpad module according to claim 1, wherein the switch comprises a metal dome, wherein when the switch is pushed by the triggering film layer, the metal dome of the switch is subjected to deformation, so that the metal dome is contacted with the circuit board.

9. A computing device, comprising:
a casing, wherein a fixing frame is concavely formed in the casing;
a processor disposed within the casing; and
a touchpad module disposed within the fixing frame of the casing and electrically connected with the processor, wherein the touchpad module comprises:
a touch member disposed within the fixing frame, wherein the touch member comprises a circuit board and a covering plate, and the covering plate is located over the circuit board;
a switch disposed on the circuit board;
a base plate disposed within the fixing frame and opposed to the circuit board, wherein the base plate comprises a perforation, and the switch is aligned with the perforation; and
a triggering film layer arranged between the base plate and the switch, wherein the perforation of the base plate is covered by the triggering film layer.
